(19) United States
(12) Patent Application Publication
(10) Pub. No.: US 2006/0045016 A1
(43) Pub. Date: Mar. 2, 2006

(54) Method and apparatus for managing packet data network loading

(76) Inventors: Jay J. Dawdy, Algonquin, IL (US); Todd M. Russell, Coral Springs, FL (US)

Correspondence Address: MOTOROLA, INC., 1303 EAST ALGONQUIN ROAD, IL01/3RD, SCHAUMBURG, IL, 60196, US

(21) Appl. No.: 10/930,972

(22) Filed: Aug. 31, 2004

(51) Int. Cl. H04J 1/16

(52) U.S. Cl. 370/235; 370/401

(57) ABSTRACT

Various embodiments are described to address the need for managing packet data network loading in a manner that is better tailored for wireless networking environments. Generally expressed, a network gateway (141) and a node (101) communicate to establish a packet data session. When conditions warrant, the network gateway sends a back-off message to the node that indicates a period of time for which the node is to suspend sending packet data to the network gateway for the packet data session and for which the node may suspend monitoring a data channel (112) for packet data from the network gateway for the packet data session. After the period of time (i.e., the back-off period) expires the network gateway and the node resume packet data exchange for the packet data session.

### FIELD OF THE INVENTION

The present invention relates generally to data communications and, in particular, to managing packet data network loading.

### BACKGROUND OF THE INVENTION

With an increasing demand for packet data services, more and more consumer networking devices are now packet data-capable. Thus, networking gateways, such as gateways that bridge radio access networks (RANs) to external internet protocol (IP) networks, are experiencing greater user traffic loads. Existing means for managing packet data network loading are not particularly well tailored for the somewhat unique circumstances of wireless network nodes. For example, in contrast to wired networking devices, wireless nodes typically strive to conserve battery life and wireless communication resources and often provide multiple wireless services, which may contend for the same limited resources when used concurrently. Accordingly, it would be highly desirable to have a method and apparatus for managing packet data network loading that is better tailored for wireless networking environments.

### BRIEF DESCRIPTION OF THE DRAWINGS

FIG. 1 is a block diagram depiction of a wireless communication system in accordance with multiple embodiments of the present invention.

FIG. 2 is a logic flow diagram of functionality performed by a network gateway in accordance with multiple embodiments of the present invention.

FIG. 3 is a logic flow diagram of functionality performed by a network node in accordance with multiple embodiments of the present invention.

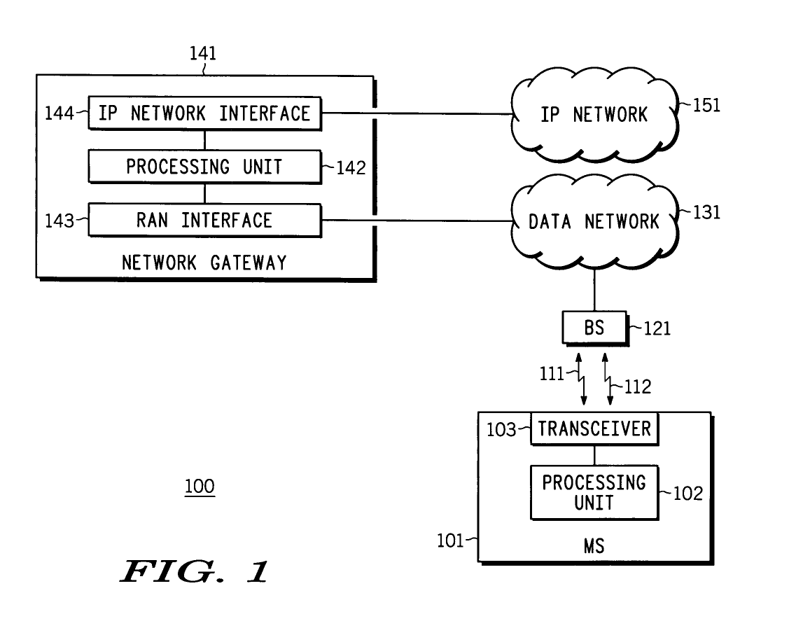

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to address the need for managing packet data network loading in a manner that is better tailored for wireless networking environments. Generally expressed, a network gateway and a node communicate to establish a packet data session. When conditions warrant, the network gateway sends a back-off message to the node that indicates a period of time for which the node is to suspend sending packet data to the network gateway for the packet data session and for which the node may suspend monitoring a data channel for packet data from the network gateway for the packet data session. After the period of time (i.e., the back-off period) expires the network gateway and the node resume packet data exchange for the packet data session.

The disclosed embodiments can be more fully understood with reference to FIGS. 1-3. FIG. 1 is a block diagram depiction of a wireless communication system 100 in accordance with multiple embodiments of the present invention. Communication system 100 is a well-known “IDEN”/“WiDEN” system, suitably modified to implement the present invention. Alternative embodiments of the present invention may be implemented in communication systems that employ similar technologies, as embodiments of the present invention are not limited to “IDEN”/“WiDEN” systems.

Those skilled in the art will recognize that FIG. 1 does not depict all of the network equipment necessary for system 100 to operate but only those system components and logical entities particularly relevant to the description of embodiments herein. In particular, the network equipment of system 100 comprises such components as base station (BS) 121 and network gateway 141, interconnected by a data network 131 (such as a frame relay network). Network gateway 141 serves to interconnect the RAN (which includes BS 121 and data network 131) with internet protocol (IP) network 151, which typically provides Internet access. In a typical “iDEN” system, the network gateway comprises one or more data gateways (specifically, Motorola Data Gateways) in data gateway clusters that collectively serve a group of base stations. Also, although not depicted, “iDEN” systems are well-known to comprise additional components such as, but not limited to, a mobile switching center (MSC) and a dispatch application processor (DAP).

Generally, network gateways, BSs, MSCs, DAPs, data networks, and IP networks are known in the art. For example, BSs are well-known to comprise components such as base station controllers (BSCs) and base transceiver systems (BTSs), neither of which are specifically shown in FIG. 1. Also, network gateways are well-known to comprise components such as processing units, IP network interfaces, and RAN interfaces.

In general, components such as processing units and network interfaces are well-known. For example, processing units are known to comprise basic components such as, but not limited to, microprocessors, microcontrollers, memory devices, and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement a network gateway processing unit that performs the given logic. Therefore, network gateway 141 represents a known network gateway that has been adapted, in accordance with the description herein, to implement embodiments of the present invention.

In “iDEN” system 100, mobile station (MS) 101 serves as a network node. BS 121 and MS 101 use an air interface comprising channel groups 111 and 112 to communicate. Channel group 111 comprises a variety of well-known channel types, such as paging channels, access channels, and common control channels. Channel group 112 comprises common packet data channels, portions of which are dynamically used to support packet data services for individual users.

Terminology in the art commonly refers to nodes or user devices as mobile stations (MSs); however, nodes are not necessarily mobile nor able to move. Thus, node platforms are known in the art to include devices such as mobile phones, computers, personal digital assistants, gaming devices, etc. In particular, MS 101 comprises MS processing unit 102, transceiver 103, a keypad (not shown), a speaker (not shown), a microphone (not shown), a battery (not shown), and a display (not shown). Processing units, transceivers, keypads, speakers, microphones, batteries, and displays as used in MSs are generally well-known in the art.

For example, MS processing units are known to comprise basic components such as, but not limited to, microprocessors, digital signal processors (DSPs), microcontrollers, memory devices, and/or logic circuitry. Such MS components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging flow, and/or a protocol specification, those skilled in the art are aware of the many design and development techniques available to implement an MS that performs the given logic. Thus, MS 101 represents a known MS that has been adapted, in accordance with the description herein, to implement embodiments of the present invention.

Operation of embodiments in accordance with the present invention occurs substantially as follows. Relevant operation begins with processing unit 142, via RAN interface 143, communicating with processing unit 102, via transceiver 103, to establish a packet data session between network gateway 141 and MS 101. In fact, many additional MSs will also communicate with network gateway 141 to establish individual packet data sessions. Primarily, these data sessions are established to obtain access to IP-based information and services, since it is the network gateway that provides this connectivity in system 100. As an example, MS 101 may send/receive information for its data session with network gateway 141 via an uplink/downlink data channel in channel group 112.

As the packet data bandwidth needs for each MS varies with time, occasionally the data traffic may approach overload levels. Processing unit 142 of network gateway 141 detects when its data traffic reaches a loading threshold (such as 98% of capacity), and in response, proceeds to select for temporary service suspension one or more MSs from those with established packet data sessions. The process of selecting may be implemented to consider a variety of factors. For example, network gateway 141 may determine which MSs are using more packet data bandwidth than others and select these MSs. Presumably, this would enable network gateway 141 to select fewer MSs. Alternatively or in combination with this first factor, network gateway 141 may determine which MSs are associated with a lower tier of service and/or which have a lower priority than others and select these MSs. Thus, those subscribing to a higher level of service would be less likely to experience suspended packet data service.

Processing unit 142 of network gateway 141 also determines a period of time for which to suspend packet data service to each MS. Again, this determination may be based on a service tier associated with the MS. For example, lower tiered MSs may be selected for longer service suspensions than those associated with higher tiers. Alternatively or in combination with service tier considerations, network gateway 141 may determine a suspension time period based on when network gateway 141 anticipates that network gateway data traffic will fall below a threshold.

Processing unit 142 then sends, via RAN interface 143, a back-off message to MS 101 (assuming for illustration purposes that MS 101 is selected). The back-off message indicates for the packet data session the period of time determined for MS 101 to suspend sending packet data to network gateway 141. The indicated time period is also a period for which MS 101 may suspend monitoring the downlink data channel in channel group 112 for the packet data session. Thus, upon receiving the back-off message via transceiver 103, processing unit 102 of MS 101 suspends the transfer of any packet data waiting to be sent to network gateway 141 for the packet data session. Processing unit 102 also suspends monitoring the downlink data channel for packet data for the packet data session.

The ability to suspend both data transfer and monitoring is a substantial advantage in the wireless environment. MS 101 can transition to an idle operating mode or some other battery-saving mode, for example, during packet data service suspension. In addition, MS 101 can participate in other communication services during suspension. For example, MS 101 may participate in a dispatch (or push-to-talk) call, which it may otherwise not have been able to had it been necessary to continue monitoring for packet data.

During the time period indicated by the back-off message, processing unit 142 of network gateway 141 suspends the transfer of any packet data waiting to be sent for the packet data session to MS 101 for the period of time indicated. At the end of the time period, packet data exchange for the packet data session may resume. In other words, either MS 101 or network gateway 141 may resume sending packet data for the data session.

However, before the back-off period expires and while the packet data session is suspended, network gateway 141 may decide to resume the session early. For example, in some embodiments a network gateway may decide to resume in response to receiving packet data for the MS. Alternatively or additionally, a network gateway may decide to resume in response to detecting that the network gateway data traffic has fallen below a threshold.

Whatever the reason, processing unit 142 indicates to MS 101, via RAN interface 143, that MS 101 may resume sending packet data to network gateway 141 for the packet data session and that MS 101 should resume monitoring the data channel for the packet data session. Since MS 101 is not monitoring the downlink data channel in channel group 112 during the back-off period, the indication to MS 101 must be made via signaling on another channel. For example, MS 101 may be paged to resume the packet data session early. Packet data exchange for the packet data session may thus resume prior to the back-off period expiring.

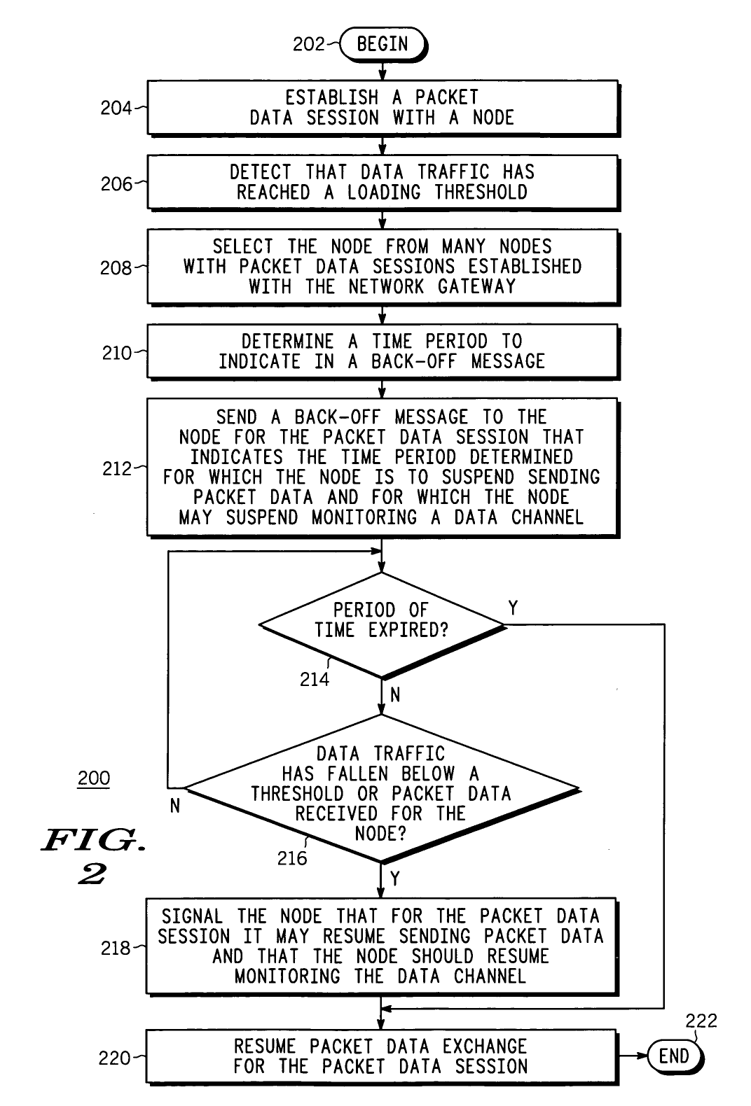

FIG. 2 is a logic flow diagram of functionality performed by a network gateway in accordance with multiple embodiments of the present invention. Logic flow 200 begins (202) with the network gateway communicating with a node to establish (204) a data session. At some point in time, the network gateway detects (206) that its data traffic has reached an established loading threshold. The network gateway then selects (208) the node, for example, (and possibly other nodes with established data sessions) and determines (210) a back-off time period for the node. Indicating the time period determined, the network gateway sends (212) a back-off message to the node. The back-off message indicates, for the packet data session, a period of time for which the node is to suspend sending packet data to the network gateway and for which the node may suspend monitoring its data channel for packet data from the network gateway.

While the back-off period is running (214), the network gateway monitors for events that would provide a reason to resume packet data service early. The set of such events chosen differs depending on the embodiment. In the embodiments depicted, network gateway data traffic falling below a loading threshold or packet data newly received for the node (216) would trigger early packet data service resumption. Accordingly, the network gateway signals (218) the node that it may resume sending packet data to the network gateway for the packet data session and that the node should resume monitoring its data channel for packet data from the network gateway for the packet data session. Thus, with the expiring of the back-off time period or sooner, packet data exchange for the packet data session is resumed (220), and logic flow 200 ends (222).

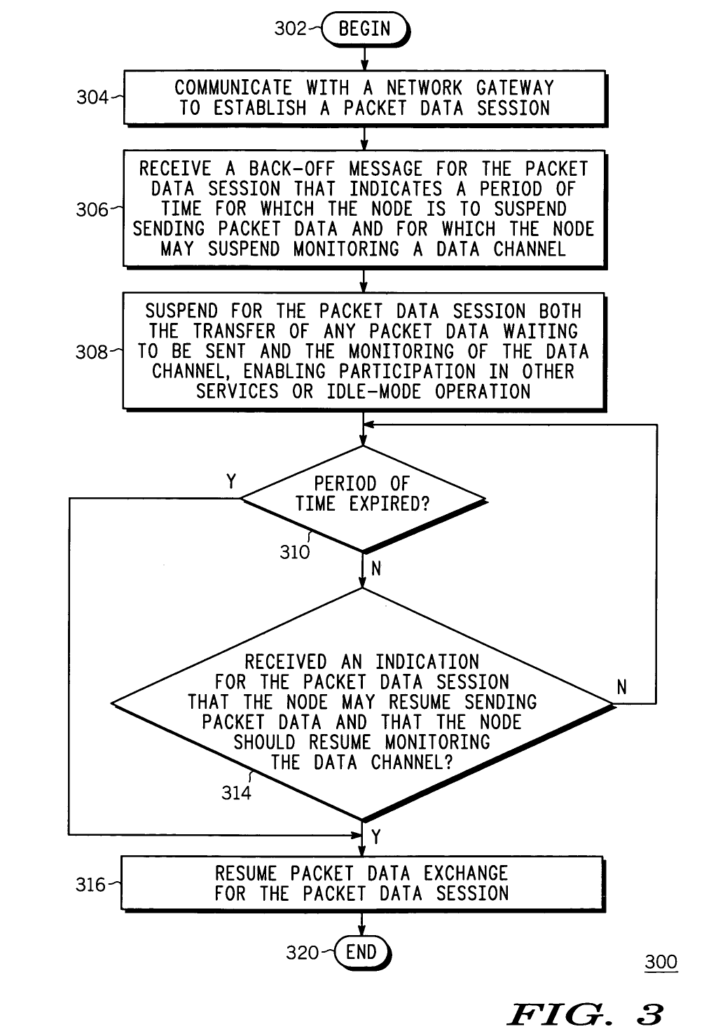

FIG. 3 is a logic flow diagram of functionality performed by a network node in accordance with multiple embodiments of the present invention. Logic flow 300 begins (302) with the node communicating with a network gateway to establish (304) a data session. At some point in time, the node receives (306) a back-off message from the network gateway. As the back-off message indicates for the packet data session, the node suspends (308) sending packet data to the network gateway and suspends monitoring its data channel for packet data from the network gateway. Instead, the node may participate in other communication services or transition to an idle mode to conserve battery life. While the back-off period is running (310), the node may receive signaling (314) for the packet data session to resume monitoring its data channel for packet data from the network gateway and to resume sending packet data to the network gateway. Thus, upon receiving such signaling or with the expiring of the back-off time period, packet data exchange for the packet data session is resumed (316), and logic flow 300 ends (320).

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for managing packet data network loading comprising:
establishing, by a network gateway, a packet data session with a node;
sending, by the network gateway, a back-off message to the node that indicates a period of time for which the node is to suspend sending packet data to the network gateway for the packet data session and for which the node may suspend monitoring a data channel for packet data from the network gateway for the packet data session; and
resuming, by the network gateway, packet data exchange for the packet data session after the period of time expires.

2. The method of claim 1, further comprising:
detecting, by the network gateway, that network gateway data traffic has reached a loading threshold; and
selecting, by the network gateway in response to detecting, the node from a plurality of nodes with packet data sessions established with the network gateway.

3. The method of claim 2, wherein
selecting the node comprises selecting based on a determination that the node has a lower priority than other nodes from the plurality of nodes with packet data sessions established with the network gateway.

4. The method of claim 2, wherein
selecting the node comprises selecting based on a determination that the node is associated with a lower tier of service than other nodes from the plurality of nodes with packet data sessions established with the network gateway.

5. The method of claim 2, wherein
selecting the node comprises selecting based on a determination that the node is using more packet data bandwidth than other nodes from the plurality of nodes with packet data sessions established with the network gateway.

6. The method of claim 2, further comprising:
determining, by the network gateway, the period of time indicated in the back-off message based on when the network gateway anticipates that network gateway data traffic will fall below a threshold.

7. The method of claim 1, further comprising:
determining, by the network gateway, the period of time indicated in the back-off message based on a service tier associated with the node.

8. The method of claim 1, further comprising:
suspending, by the network gateway, the transfer of any packet data waiting to be sent for the packet data session to the node for the period of time indicated.

9. The method of claim 1, further comprising:
indicating, by the network gateway to the node prior to the period of time expiring, that the node may resume sending packet data to the network gateway for the packet data session and the node should resume monitoring the data channel for packet data from the network gateway for the packet data session; and
resuming, by the network gateway, packet data exchange for the packet data session after indicating that the node may resume but prior to the period of time expiring.

10. The method of claim 9, wherein
indicating that the node may resume comprises signaling the node via a channel other than the data channel.

11. The method of claim 10, wherein
indicating that the node may resume comprises paging the node.

12. The method of claim 9, wherein
indicating that the node may resume comprises indicating in response to receiving packet data for the node.

13. The method of claim 9, wherein
indicating that the node may resume comprises indicating in response to detecting that network gateway data traffic has fallen below a threshold.

14. The method of claim 1, wherein
resuming packet data exchange for the packet data session consists of sending packet data for the packet data session to the node.

15. The method of claim 1, wherein
resuming packet data exchange for the packet data session consists of receiving packet data for the packet data session from the node.

16. A method for managing packet data network loading comprising:
communicating, by a node with a network gateway, to establish a packet data session;
receiving, by the node, a back-off message that indicates a period of time for which the node is to suspend sending packet data to the network gateway for the packet data session and for which the node may suspend monitoring a data channel for packet data from the network gateway for the packet data session;
suspending, by the node, the transfer of any packet data waiting to be sent for the packet data session to the network gateway and the monitoring of the data channel for packet data for the packet data session from the network gateway; and
resuming, by the node, packet data exchange for the packet data session after the period of time expires.

17. The method of claim 16, wherein suspending by the node the transfer and the monitoring comprises transitioning by the node to an idle operating mode.

18. The method of claim 16, wherein suspending by the node the transfer and the monitoring comprises participating by the node in communication services other than the packet data session.

19. The method of claim 16, further comprising:
receiving, from the network gateway prior to the period of time expiring, an indication that the node may resume sending packet data to the network gateway for the packet data session and that the node should resume monitoring the data channel for packet data from the network gateway for the packet data session; and
resuming, by the node, packet data exchange for the packet data session after receiving the indication that the node may resume but prior to the period of time expiring.

20. The method of claim 19, wherein receiving the indication that the node may resume comprises receiving the indication via a channel other than the data channel.

21. The method of claim 20, wherein receiving the indication that the node may resume comprises receiving a page.

22. The method of claim 16, wherein resuming packet data exchange for the packet data session consists of sending packet data for the packet data session to the network gateway.

23. The method of claim 16, wherein resuming packet data exchange for the packet data session consists of receiving packet data for the packet data session from the network gateway.

24. A network gateway for managing packet data network loading, the network gateway comprising:
a radio access network (RAN) interface adapted to send and receive messaging to and from a RAN;
an IP network interface adapted to send and receive messaging to and from an IP network; and
a processing unit, communicatively coupled to the RAN interface and the IP network interface,
adapted to establish, via the RAN interface, a packet data session with a node,
adapted to send, via the RAN interface, a back-off message to the node that indicates a period of time for which the node is to suspend sending packet data to the network gateway for the packet data session and for which the node may suspend monitoring a data channel for packet data from the network gateway for the packet data session, and
adapted to resume, via the RAN interface, packet data exchange for the packet data session after the period of time expires.

25. The network gateway of claim 24, wherein the network gateway comprises at least one data gateway from a cluster of data gateways.

26. A node for managing packet data network loading, the node comprising:
a transceiver; and
a processing unit, communicatively coupled to the transceiver,
adapted to communicate, via the transceiver with a network gateway, to establish a packet data session with the network gateway,
adapted to receive, via the transceiver, a back-off message that indicates a period of time for which the node is to suspend sending packet data to the network gateway for the packet data session and for which the node may suspend monitoring a data channel for packet data from the network gateway for the packet data session,
adapted to suspend the transfer of any packet data waiting to be sent for the packet data session to the network gateway and the monitoring of the data channel for packet data for the packet data session from the network gateway, and
adapted to resume, via the transceiver, packet data exchange for the packet data session after the period of time expires.

27. The node of claim 26, wherein the node comprises a mobile station (MS).
